(19) United States
(12) Patent Application Publication
(10) Pub. No.: US 2018/0248943 A1
(43) Pub. Date: Aug. 30, 2018

(54) INFORMATION PROCESSING SYSTEM, INFORMATION PROCESSING METHOD, AND INFORMATION PROCESSING DEVICE

(71) Applicant: FUJITSU LIMITED, Kawasaki-shi (JP)

(72) Inventor: Takashi Imai, Atsugi (JP)

(73) Assignee: FUJITSU LIMITED, Kawasaki-shi (JP)

(21) Appl. No.: 15/899,483

(22) Filed: Feb. 20, 2018

(30) Foreign Application Priority Data
Feb. 27, 2017 (JP) 2017-035279

(51) Int. Cl. H04L 29/08

(52) U.S. Cl. CPC H04L 67/1095; H04W 84/18; H04L 67/1076

(57) ABSTRACT

Provided is an information processing system for synchronizing data among nodes, wherein each of the nodes includes a processor configured to: determine from among the nodes a node that has responsibility for distribution of the data based on a distributed algorithm common to all the nodes; and distribute information for identifying a determined node to a remaining node other than the determined node.

### CROSS-REFERENCE TO RELATED APPLICATION

This application is based upon and claims the benefit of priority of the prior Japanese Patent Application No. 2017-035279 filed on Feb. 27, 2017, the entire contents of which are incorporated herein by reference.

### FIELD

A certain aspect of the embodiments is related to an information processing system, an information processing method, and an information processing device.

### BACKGROUND

There has been known a system for sharing data among communication terminals (hereinafter, referred to as nodes) communicating with each other over a radio. As one of such systems, there has been known a system for sharing data in a distributed manner at individual nodes without using a server as disclosed in, for example, International Publication No. 2014/128807.

There has been also known election algorithms for electing a representative node responsible for distribution of data from among nodes without using a server in such systems. For example, a bully algorithm and a ring algorithm have been known as such election algorithms.

### SUMMARY

According to an aspect of the embodiments, there is provided an information processing system for synchronizing data among nodes, wherein each of the nodes includes a processor configured to: determine from among the nodes a node that has responsibility for distribution of the data based on a distributed algorithm common to all the nodes; and distribute information for identifying a determined node to a remaining node other than the determined node.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for describing an exemplary information processing system;

FIG. 2 illustrates a hardware configuration of a node;

FIG. 3 is a block diagram of the node;

FIG. 4 illustrates a data storage unit;

FIG. 5 illustrates a distributor information storage unit;

FIG. 6 illustrates a handoff information storage unit;

FIG. 7 is a flowchart of a process at the time of updating data;

FIG. 8 is a flowchart of a process at the time of receiving data;

FIG. 9 is a flowchart (No. 1) of a process at the time of receiving handoff information;

FIG. 10 is a flowchart (No. 2) of the process at the time of receiving the handoff information;

FIG. 11 is a flowchart of a process at the time of detecting withdrawal;

FIG. 12 is a flowchart of a process at the time of receiving a handoff request; and

FIG. 13 is a flowchart of a process at the time of detecting participation.

### DESCRIPTION OF EMBODIMENTS

As described previously, a bully algorithm and a ring algorithm have been known as election algorithms. However, such election algorithms elect a representative node after obtaining consensus from individual nodes. In more detail, the election algorithm elects a representative node after reaching a consensus about which node has the responsibility for distribution of data from all the nodes participating in the system. Thus, a huge amount of communication occurs until the representative node is elected. In addition, under a wireless communication environment, nodes can move freely. Thus, the communication state between nodes changes rapidly, and a stable communication state is therefore difficult to maintain. Under such situations in which a stable communication is difficult to maintain, if participation of a node into the system or withdrawal of a node from the system frequently occurs, it may take a lot of time to elect a representative node. Delay in election of a representative node leads to delay in data distribution, and it takes time for data to be consistent among nodes.

Hereinafter, a description will be given of an embodiment of the present case with reference to the accompanying drawings.

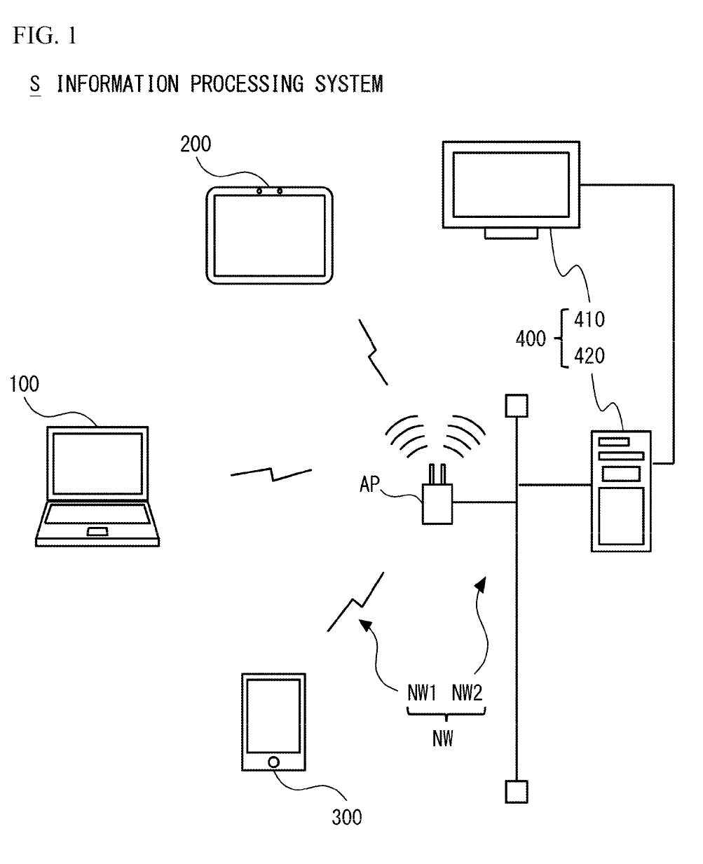

FIG. 1 is a diagram for describing an exemplary information processing system S. The information processing system S is a computer system that achieves eventual consistency. The information processing system S includes nodes 100, 200, 300, and 400 as information processing devices. The node 400 includes a display device 410 and a control device 420 that controls the display device 410.

The nodes 100, 200, 300, and 400 are connected to each other over a communication network NW including a wireless base station (for example, an access point) AP. As illustrated in FIG. 1, the communication network NW includes a wired network NW1 and a wireless network NW2. Thus, the nodes 100, 200, 300, and 400 are able to communicate with each other by any of air and wire. Accordingly, the information processing system S allows documents or blueprints displayed on each of the nodes 100, 200, 300, and 400 to be co-edited by manipulating them at any of the nodes 100, 200, 300, and 400. An ad hoc network without the wireless base station AP may be used among the nodes 100, 200, and 300.

Here, examples of the nodes 100, 200, 300, and 400 include, but are not limited to, terminal devices and smart devices. Examples of the terminal device include, but are not limited to, a portable (mobile) personal computer (PC) and a stationary (desktop) PC. Examples of the smart device include, but are not limited to, a smartphone, a smartwatch, a tablet terminal, and a wearable computer. The nodes 100, 200, 300, and 400 are not limited to terminal devices or smart devices, and may be home appliances such as smart televisions, microwaves, and healthcare commodities, digital cameras, or handheld gaming devices as long as they have a display function and a communication function. The nodes 100, 200, 300, and 400 share data by transmitting data including identical identification information, called a Key, to each other.

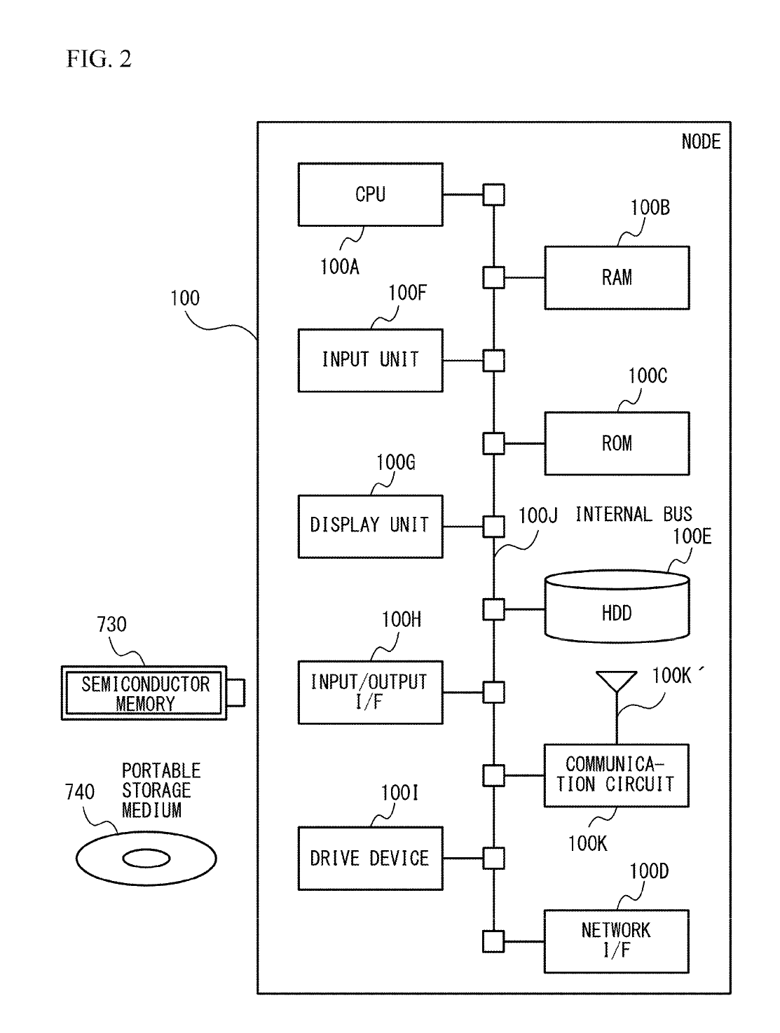

Next, with reference to FIG. 2, a description will be given of a hardware configuration of the node 100. The above nodes 200, 300, and 400 basically have the same hardware configuration as the node 100, and the description thereof is thus omitted.

FIG. 2 illustrate a hardware configuration of the node 100. As illustrated in FIG. 2, the node 100 includes at least a central processing unit (CPU) 100A, a random access memory (RAM) 100B, a read only memory (ROM) 100C, a network interface (I/F) 100D, and a communication circuit 100K. An antenna 100K′ is coupled to the communication circuit 100K. Instead of the communication circuit 100K, a CPU that implements a communication function may be used. The node 100 is coupled to the nodes 200 and 300 through the communication circuit 100K and the antenna 100K′.

The node 100 also includes an input unit 100F and a display unit 100G. Examples of the input unit 100F include, but are not limited to, a keyboard, a pointing device, and a touch panel. Examples of the display unit 100G include, but are not limited to, a liquid crystal display. Furthermore, the node 100 may include at least one of a hard disk drive (HDD) 100E, an input/output I/F 100H, and a drive device 100I as necessary. The CPU 100A through the drive device 100I and the communication circuit 100K are coupled to each other via an internal bus 100J. The cooperation of at least the CPU 100A and the RAM 100B implements a computer.

A semiconductor memory 730 is coupled to the input/output I/F 100H. Examples of the semiconductor memory 730 include, but are not limited to, a universal serial bus (USB) memory and a flash memory. The input/output I/F 100H reads programs and data stored in the semiconductor memory 730. The input/output I/F 100H has, for example, a USB port.

A portable storage medium 740 is inserted into the drive device 100I. Examples of the portable storage medium 740 include, but are not limited to, a removable disk such as a compact disk (CD)-ROM and a digital versatile disk (DVD). The drive device 100I reads programs and data stored in the portable storage medium 740. The network I/F 100D includes, for example, a local area network (LAN) port.

The CPU 100A stores the programs stored in the HDD 100E in the above RAM 100B. The CPU 100A stores the programs stored in the portable storage medium 740 in the RAM 100B. The execution of the stored programs by the CPU 100A implements various functions described later, and causes various operations described later to be executed. The programs are according to flowcharts described later.

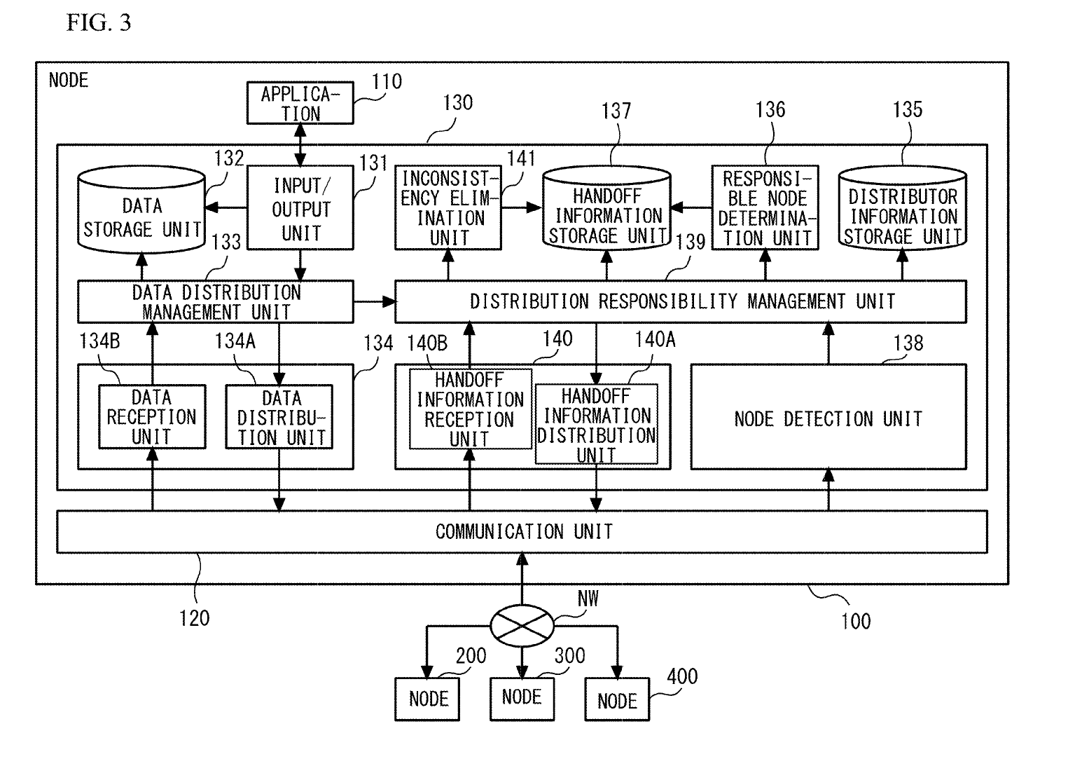

Next, with reference to FIG. 3, a functional configuration of the node 100 will be described. The above nodes 200, 300, and 400 basically have the same functional configuration as the node 100, and the description thereof is thus omitted.

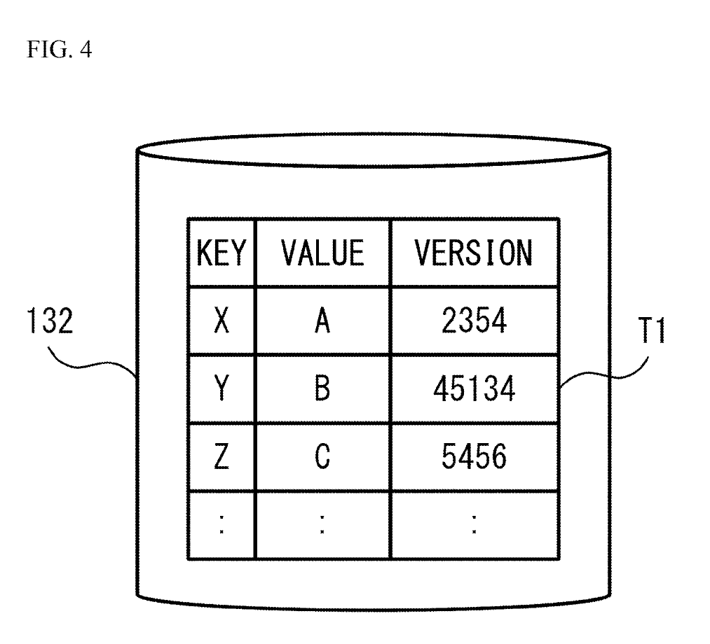

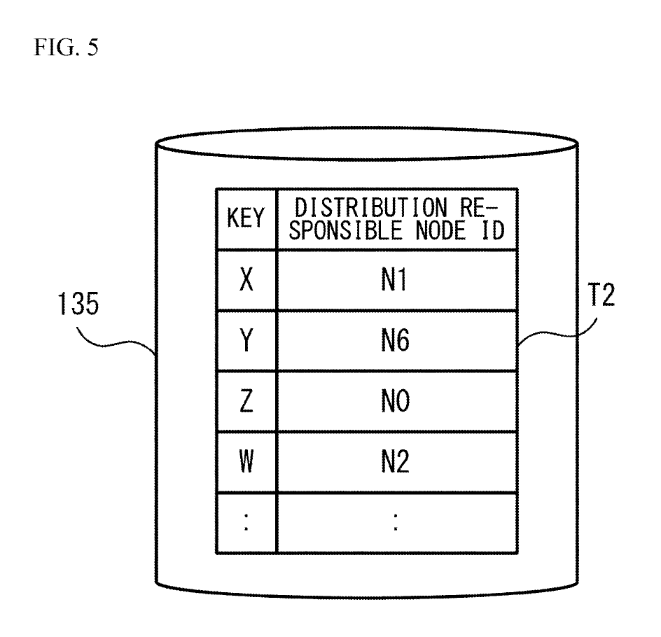

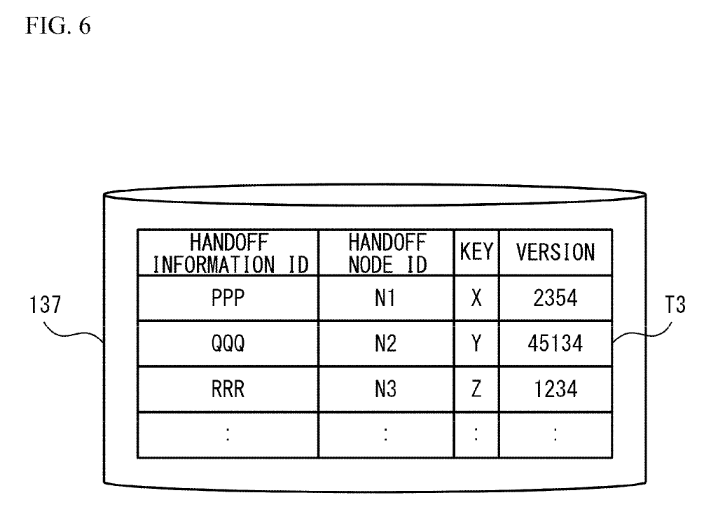

FIG. 3 is a block diagram of the node 100. FIG. 4 illustrates a data storage unit 132. FIG. 5 illustrates a distributor information storage unit 135. FIG. 6 illustrates a handoff information storage unit 137. As illustrated in FIG. 3, the node 100 includes an application 110, a communication unit 120, and a middleware 130.

The application 110 is a distributed application run on the node 100. The distributed application is written in a specific markup language such as, for example, Hyper Text Transfer Protocol (HTML), and manipulates various data. Examples of the distributed application include, but are not limited to, a screen sharing application. The communication unit 120 controls communication between the node 100 and the nodes 200, 300, and 400. For example, the communication unit 120 specifies at least one of the nodes 200, 300, and 400, and transmits data manipulated by the application 110 to the specified node. For example, the communication unit 120 notifies the middleware 130 of a new node (not illustrated) that newly participates in the information processing system S and a node (for example, the node 300) that withdraws from the information processing system S.

When data is manipulated by the application 110, the middleware 130 reports the manipulation to the middleware (not illustrated) of the nodes 200, 300, and 400. When the communication state is unstable or the number of nodes has increased and the middleware 130 determines that the communication volume of data manipulation to be reported exceeds the communications capacity, the middleware 130 stops reporting the manipulation. Additionally, the middleware 130 executes various processes.

More specifically, the middleware 130 includes, as illustrated in FIG. 3, an input/output unit 131, the data storage unit 132, a data distribution management unit 133, and a data transmission/reception unit 134. The data transmission/reception unit 134 includes a data distribution unit 134A and a data reception unit 134B. The middleware 130 also includes the distributor information storage unit 135, a responsible node determination unit 136, the handoff information storage unit 137, and a node detection unit 138. The middleware 130 further includes a distribution responsibility management unit 139, an information transmission/reception unit 140, and an inconsistency elimination unit 141. The information transmission/reception unit 140 includes a handoff information distribution unit 140A and a handoff information reception unit 140B.

The input/output unit 131 is an interface between the application 110 and the middleware 130. The input/output unit 131 updates the data storage unit 132 when data is manipulated by the application 110. For example, when data is written by the application 110, the input/output unit 131 receives data from the application 110, and writes the received data in the data storage unit 132 when there is no data having the same key as the received data in the data storage unit 132. This process allows the data storage unit 132 to store data to be shared with the nodes 200, 300, and 400 that communicate with the node 100. In addition, the input/output unit 131 outputs manipulation of data by the application 110 to the data distribution management unit 133. Furthermore, the input/output unit 131 monitors the data storage unit 132, and when the data storage unit 132 is updated based on data received from the nodes 200, 300, or 400, the input/output unit 131 reports the update to the application 110.

As illustrated in FIG. 4, the data storage unit 132 manages the data written by the input/output unit 131 with a data table T1. Each piece of data includes a Key, a Value, and a version as constituent elements. The Key is identification information for identifying data. The version is, for example, a logical clock such as the Lamport clock. A vector clock or the system clock of an operating system (OS) may be used as a logical clock. FIG. 4 illustrates Key-Value type data, but data is not limited to Key-Value type data.

When receiving data manipulation output from the input/output unit 131, the data distribution management unit 133 reports the receipt of the data manipulation to the distribution responsibility management unit 139. Additionally, when receiving data manipulation, the data distribution management unit 133 obtains data from the data storage unit 132, and outputs the obtained data to the data transmission/reception unit 134. More specifically, the data distribution management unit 133 outputs the obtained data to the data distribution unit 134A. Furthermore, when receiving data output from the data transmission/reception unit 134, the data distribution management unit 133 updates the data storage unit 132. For example, when receiving data output from the data reception unit 134B, the data distribution management unit 133 writes the received data in the data storage unit 132 when there is no data having the same key as the received data in the data storage unit 132.

The data distribution unit 134A distributes the data output from the data distribution management unit 133 to the nodes 200, 300, and 400 through the communication unit 120. On the other hand, the data reception unit 134B receives data distributed from each of the nodes 200, 300, and 400 through the communication unit 120.

The distributor information storage unit 135 stores distributor information. More specifically, as illustrated in FIG. 5, the distributor information storage unit 135 manages the distributor information with a distributor information table T2. Each piece of the distributor information includes a Key and a distribution responsible node ID as constituent elements. The distribution responsible node ID is identification information of the node 100, 200, 300, or 400 that has the responsibility for distribution of data. For example, for data having the Key “X”, the node to which the node ID “N1” is allocated (e.g., the node 200) has the responsibility for distribution. As described above, the distribution responsible node ID is related to a Key. The distribution responsibility management unit 139 can know which of the nodes 100, 200, 300, and 400 has the responsibility for distribution of data by checking the distributor information.

The responsible node determination unit 136 determines from among the nodes 100, 200, 300, and 400 a node that has the responsibility for distribution of data as a distribution responsible node based on a specific distributed algorithm when the distribution responsibility management unit 139 updates the handoff information storage unit 137. Used as the specific distributed algorithm is consistent hashing. The responsible node determination unit (not illustrated) of each of the nodes 200, 300, and 400 also uses the distributed algorithm common to (or the same distributed algorithm as, or the distributed algorithm having the same characteristic as) the specific distributed algorithm used by the responsible node determination unit 136 to determine a distribution responsible node.

When one of the nodes 200, 300, and 400 has withdrawn from the information processing system S and the node that has withdrawn (e.g., the node 300) is a distribution responsible node, the handoff information storage unit 137 stores handoff information for handing off the distribution responsibility of the node that has withdrawn to another node (e.g., the node 100, 200, or 400). More specifically, as illustrated in FIG. 6, the handoff information storage unit 137 manages the handoff information with a handoff information table T3. Each piece of the handoff information includes a handoff information ID, a handoff node ID, a Key, and a version as constituent elements. The handoff information ID is identification information for identifying the handoff information. The handoff node ID is identification information for identifying the node to which the distribution responsibility is handed off. As described above, even when the node 300 withdraws from the information processing system S, the distribution responsibility is handed off to one of the nodes 100, 200, and 400 remaining in the information processing system S by the handoff information.

The node detection unit 138 detects participation of a new node (not illustrated) into the information processing system S based on the report from the communication unit 120. Additionally, the node detection unit 138 detects withdrawal of a node (e.g., at least one of the nodes 200, 300, and 400) from the information processing system S based on the report from the communication unit 120. When detecting participation or withdrawal of a node, the node detection unit 138 reports the participation or the withdrawal of the node to the distribution responsibility management unit 139.

When manipulation of data is reported from the data distribution management unit 133, the distribution responsibility management unit 139 controls the operation of the responsible node determination unit 136, the information transmission/reception unit 140, and the inconsistency elimination unit 141. For example, the distribution responsibility management unit 139 updates the distributor information storage unit 135 when manipulation of data is reported from the data distribution management unit 133. Additionally, the distribution responsibility management unit 139 executes various information processing.

The handoff information distribution unit 140A distributes handoff information to the nodes 200, 300, and 400 through the communication unit 120. The handoff information reception unit 140B receives the handoff information distributed from the nodes 200, 300, and 400 through the communication unit 120. When receiving handoff information, the handoff information reception unit 140B outputs the handoff information to the distribution responsibility management unit 139.

The inconsistency elimination unit 141 eliminates the inconsistency about consensus among the nodes 100, 200, 300, and 400 by updating the handoff information storage unit 137. For example, when manipulation of data by the application 110 is reported from the data distribution management unit 133 by the distribution responsibility management unit 139, the inconsistency elimination unit 141 eliminates inconsistency by deleting the handoff information. For example, when the distribution responsibility management unit 139 receives the handoff information output from the handoff information reception unit 140B, the inconsistency elimination unit 141 eliminates inconsistency by deleting the handoff information as necessary.

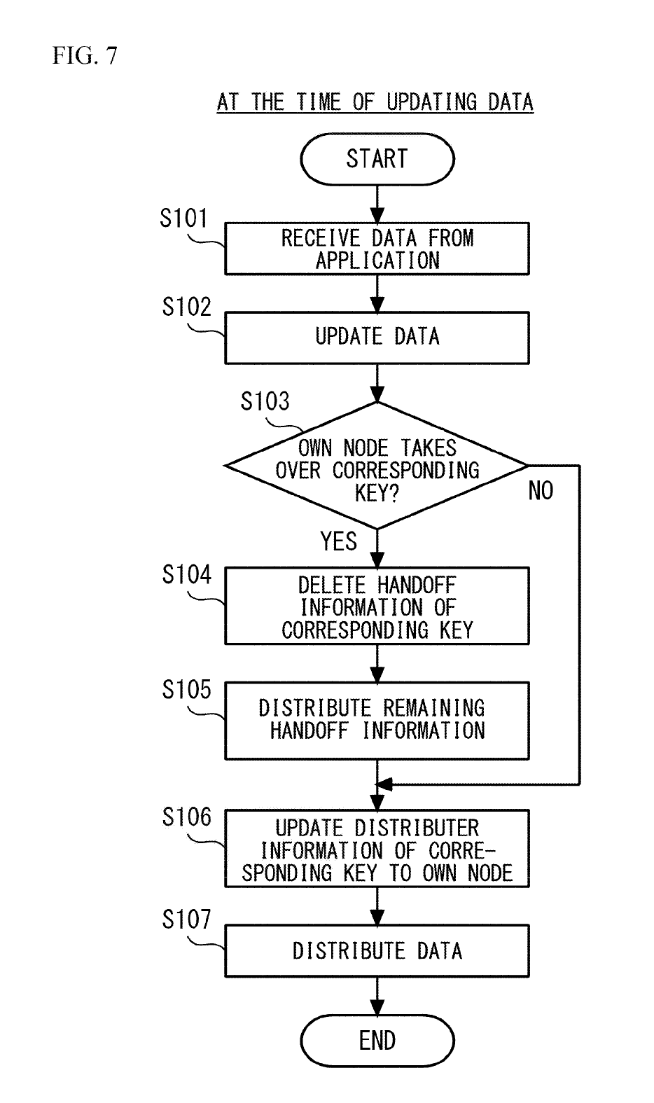

Next, with reference to FIG. 7 through FIG. 13, the operation of the node 100 will be described. The operations of the nodes 200, 300, and 400 are the same as that of the node 100, and the description thereof is thus omitted.

FIG. 7 is a flowchart of a process at the time of updating data. More specifically, FIG. 7 illustrates the process executed when the application 110 manipulates data.

First, when the application 110 manipulates data, the input/output unit 131 receives the data from the application 110 (step S101). Upon completion of the process at step S101, the input/output unit 131 updates data (step S102). More specifically, the input/output unit 131 accesses the data storage unit 132, and when there is no data having the same Key as the received data, writes the received data in the data storage unit 132. When there is data having the same key as the received data in the data storage unit 132, the input/output unit 131 checks the version thereof, and overwrites the existing data with the received data when the version of the existing data is older. The input/output unit 131 adds a version to the data when writing the data or rewriting the existing data with the data.

Upon completion of the process at step S102, the distribution responsibility management unit 139 determines whether the own node takes over the corresponding Key (step S103). More specifically, when manipulation of data is reported from the data distribution management unit 133, the distribution responsibility management unit 139 accesses the handoff information storage unit 137 and determines whether the handoff node ID of the Key of the manipulated data is the node ID allocated to the own node. When the own node has taken over the corresponding Key (step S103: YES), the inconsistency elimination unit 141 deletes the handoff information of the corresponding Key (step S104). That is, since the own node (i.e., the node 100) has the responsibility for distribution of the data manipulated by the application 110, the handoff information of the corresponding Key does not need to be held. Thus, the inconsistency elimination unit 141 deletes the handoff information of the corresponding Key.

Upon completion of the process at step S104, the handoff information distribution unit 140A distributes the remaining handoff information (step S105). More specifically, after deleting the handoff information of the corresponding Key, the distribution responsibility management unit 139 obtains the handoff information remaining in the handoff information storage unit 137, and outputs the remaining handoff information to the handoff information distribution unit 140A. The handoff information distribution unit 140A distributes the handoff information output from the distribution responsibility management unit 139. This process causes each of the nodes 200, 300, and 400 that has received the distributed handoff information to update the handoff information of its own. Accordingly, the handoff information held by each of the nodes 100, 200, 300, and 400 is synchronized. The handoff information distribution unit 140A may distribute information indicating that the handoff information is deleted.

When the process at step S105 is completed or when the distribution responsibility management unit 139 determines that the own node does not hold the handoff information of the corresponding Key (step S103: NO), the distribution responsibility management unit 139 updates the distributor information of the corresponding Key to the own node (step S106). Therefore, when the application 110 manipulates data, it is identified that the node (e.g., the node 100) including the application 110 has the responsibility for distribution of the data of the corresponding Key.

Upon completion of the process at step S106, the data distribution unit 134A distributes data (step S107), and ends the process. More specifically, the data distribution management unit 133 obtains data from the data storage unit 132 and outputs the obtained data to the data distribution unit 134A. The data distribution unit 134A distributes the data output from the data distribution management unit 133, and ends the process. The above process allows the nodes 200, 300, and 400 to receive the data distributed from the node 100.

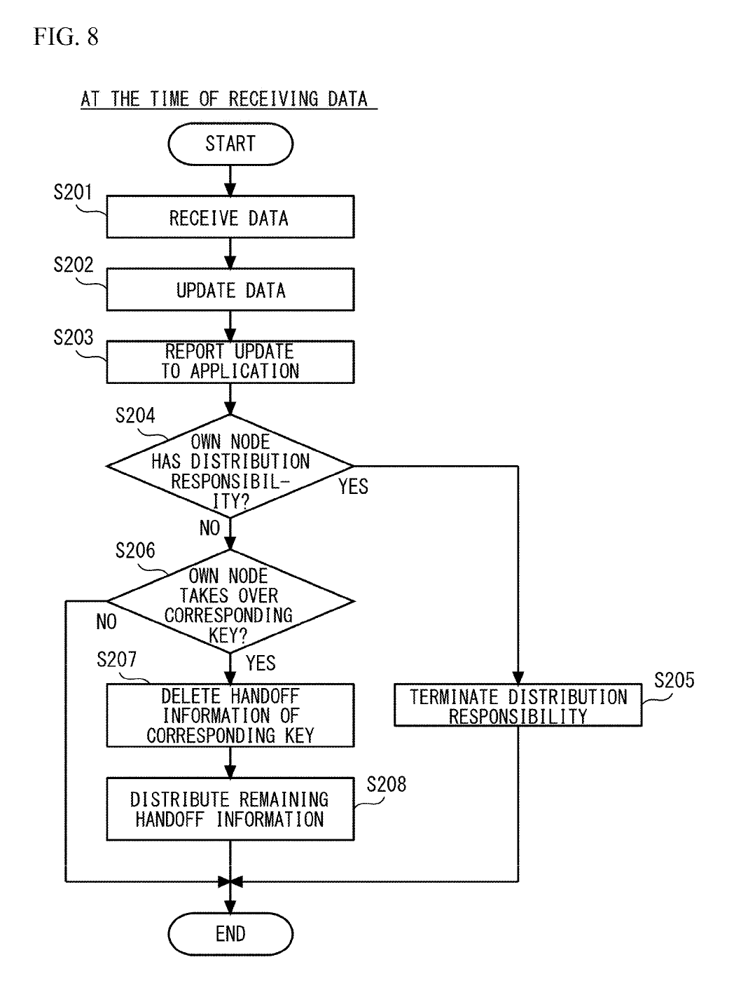

FIG. 8 is a flowchart of a process at the time of receiving data. More specifically, FIG. 8 illustrates a process executed when the data reception unit 134B receives data.

First, the data reception unit 134B receives data (step S201). For example, the data reception unit 134B receives data distributed by a node (e.g., the node 200) other than the node 100. Upon completion of the process at step S201, the data distribution management unit 133 updates data (step S202). More specifically, when the data reception unit 134B receives data, the data reception unit 134B outputs the received data to the data distribution management unit 133. Thus, the data distribution management unit 133 receives the data output from the data reception unit 134B, and writes the received data in the data storage unit 132 or overwrites data stored in the data storage unit 132 with the received data based on the Key and the version.

Upon completion of the process at step S202, the input/output unit 131 reports the update to the application 110 (step S203). More specifically, the input/output unit 131 monitors the data storage unit 132, and when the data storage unit 132 is updated, the input/output unit 131 reports the update to the application 110.

Upon completion of the process at step S203, the distribution responsibility management unit 139 determines whether the own node has the distribution responsibility (step S204). More specifically, the distribution responsibility management unit 139 accesses the distributor information storage unit 135 based on the report from the data distribution management unit 133, and determines whether the own node has the distribution responsibility in accordance with the Key of the received data. Here, when the own node has the distribution responsibility (step S204: YES), the distribution responsibility management unit 139 terminates the distribution responsibility (step S205). For example, the distribution responsibility management unit 139 terminates the distribution responsibility by deleting the corresponding distributor information. That is, when data is distributed from the node 200 based on manipulation of data by the application (not illustrated) of the node 200, the node 200 has the distribution responsibility and the node 100 does not have the distribution responsibility. Therefore, when the own node (e.g., the node 100) has the distribution responsibility, the distribution responsibility management unit 139 terminates the distribution responsibility.

On the other hand, when the own node does not have the distribution responsibility (step S204: NO), the distribution responsibility management unit 139 determines whether the own node takes over the corresponding Key (step S206). More specifically, when the receipt of data is reported from the data distribution management unit 133, the distribution responsibility management unit 139 accesses the handoff information storage unit 137, and determines whether the handoff node ID of the Key of the received data is the node ID allocated to the own node. When the own node takes over the corresponding Key (step S206: YES), the inconsistency elimination unit 141 deletes the handoff information of the corresponding Key (step S207). That is, since the node 200 has the responsibility for distribution of the data manipulated by the application (not illustrated) of the node 200, the handoff information of the corresponding Key does not need to be held. Thus, the inconsistency elimination unit 141 deletes the handoff information of the corresponding Key.

Upon completion of the process at step S207, the handoff information distribution unit 140A distributes the remaining handoff information (step S208). More specifically, after deleting the handoff information of the corresponding Key, the distribution responsibility management unit 139 obtains the handoff information remaining in the handoff information storage unit 137, and outputs the remaining handoff information to the handoff information distribution unit 140A. The handoff information distribution unit 140A distributes the handoff information output from the distribution responsibility management unit 139. The above process causes each of the nodes 200, 300, and 400 that has received the distributed handoff information to update the handoff information of its own. Accordingly, the handoff information held by each of the nodes 100, 200, 300, and 400 is synchronized. When the own node does not take over the corresponding Key (step S206: NO), the inconsistency elimination unit 141 skips the process of step S207, and the handoff information distribution unit 140A skips the process of step S208 and ends the process.

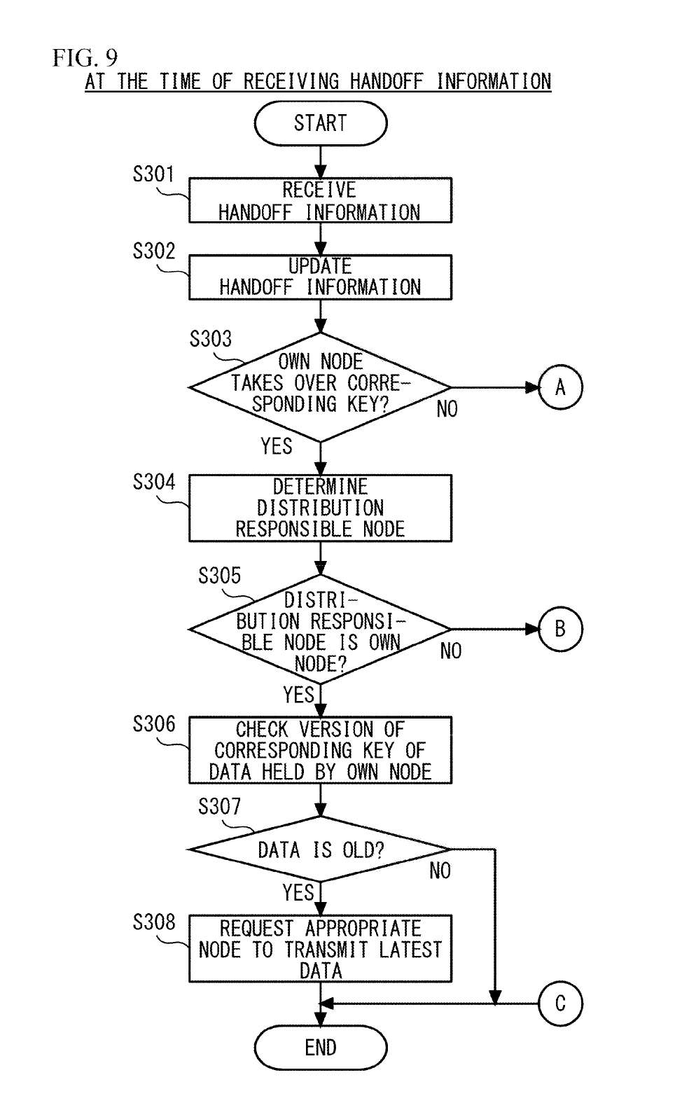

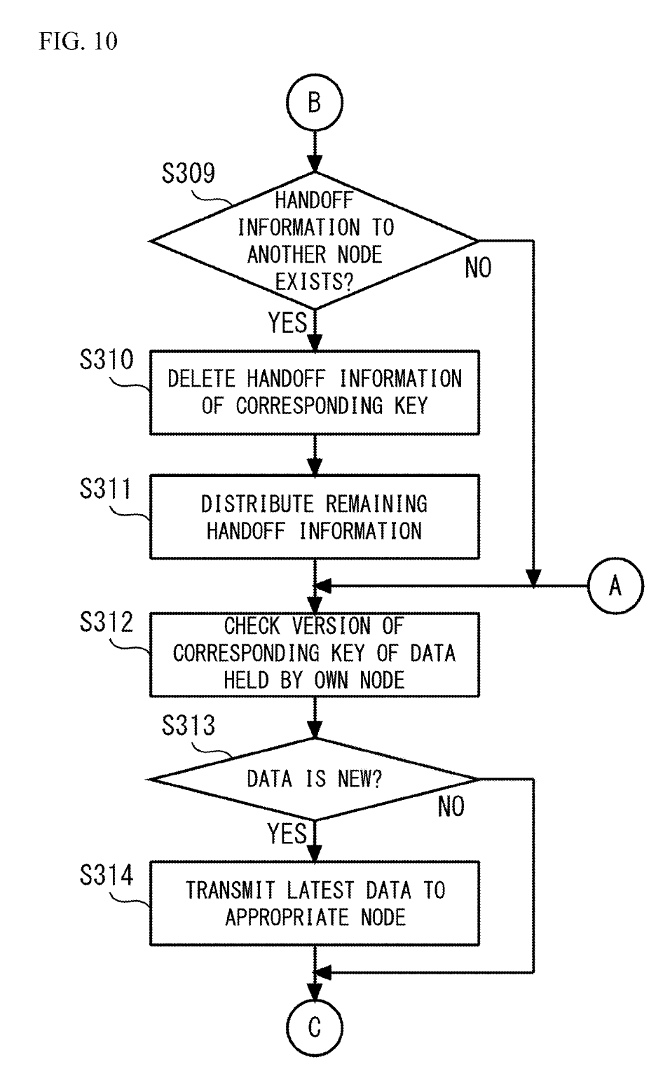

FIG. 9 is a flowchart (No. 1) of a process at the time of receiving handoff information. FIG. 10 is a flowchart (No. 2) of the process at the time of receiving the handoff information. More specifically, FIG. 9 and FIG. 10 illustrate a process executed when the handoff information reception unit 140B receives handoff information.

First, the handoff information reception unit 140B receives handoff information (step S301). For example, the handoff information reception unit 140B receives the handoff information distributed by a node (e.g., the node 200) other than the node 100. Upon completion of the process at step S301, the distribution responsibility management unit 139 updates the handoff information (step S302). More specifically, when the handoff information reception unit 140B receives handoff information, the handoff information reception unit 140B outputs the received handoff information to the distribution responsibility management unit 139. Thus, the distribution responsibility management unit 139 receives the handoff information output from the handoff information reception unit 140B, and writes the received handoff information in the handoff information storage unit 137 or overwrites data stored in the data storage unit 132 with the received data based on the Key and the version. This process makes the handoff information synchronized among the node 100, 200, 300, and 400.

Upon completion of the process at step S302, the distribution responsibility management unit 139 determines whether the own node takes over the corresponding Key (step S303). More specifically, when receiving the handoff information output from the handoff information reception unit 140B, the distribution responsibility management unit 139 accesses the handoff information storage unit 137, and determines whether the handoff node ID of the Key included in the handoff information is the ID allocated to the own node. When the own node takes over the corresponding Key (step S303: YES), the responsible node determination unit 136 determines the distribution responsible node (step S304). That is, the responsible node determination unit 136 determines whether the own node (e.g., the node 100) has the distribution responsibility or an alternate node (e.g., the node 200, 300, or 400) has the distribution responsibility.

When the distribution responsible node determined by the responsible node determination unit 136 is the own node (step S305: YES), the distribution responsibility management unit 139 checks the version of the corresponding Key of the data held by the own node (step S306). More specifically, when the responsible node determination unit 136 determines the distribution responsible node, the distribution responsibility management unit 139 checks the version of the corresponding Key through the data distribution management unit 133.

Upon completion of the process at step S306, the distribution responsibility management unit 139 determines whether the data is old (step S307). More specifically, the distribution responsibility management unit 139 compares the version of the handoff information of the corresponding Key with the version of the corresponding Key of the data held by the own node to determine whether the data is old. When the comparison result shows that the version of the corresponding Key of the data held by the own node is smaller than the version of the handoff information, the data is old (step S307: YES). In this case, the distribution responsibility management unit 139 requests an appropriate node to distribute the latest data (step S308), and ends the process. That is, the distribution responsibility management unit 139 requests the distribution responsible node to distribute the latest data, and ends the process. This process eliminates the inconsistency that data is not synchronized among the nodes 100, 200, 300, and 400. On the other hand, when the comparison result shows that the version of the corresponding Key of the data held by the own node is greater than the version of the handoff information, the data is new (step S307: NO). Thus, in this case, the distribution responsibility management unit 139 skips the process of step S308.

On the other hand, in the process at step S305, when the distribution responsible node determined by the responsible node determination unit 136 is not the own node (step S305: NO), as illustrated in FIG. 10, the distribution responsibility management unit 139 determines whether there is handoff information indicating that another node takes over the corresponding Key (step S309). More specifically, when the distribution responsible node determined by the responsible node determination unit 136 is another node, the distribution responsibility management unit 139 checks the handoff information storage unit 137, and determines whether there is handoff information indicating that another node takes over the corresponding Key.

When there is handoff information indicating that another node takes over the corresponding Key (step S309: YES), the inconsistency elimination unit 141 deletes the handoff information of the corresponding Key (step S310). That is, since another node (e.g., the node 200) has the distribution responsibility, the handoff information of the corresponding Key does not need to be held. Thus, the inconsistency elimination unit 141 deletes the handoff information of the corresponding Key.

Upon completion of the process at step S310, the handoff information distribution unit 140A distributes the remaining handoff information (step S311). More specifically, after deleting the handoff information of the corresponding Key, the distribution responsibility management unit 139 obtains the handoff information remaining in the handoff information storage unit 137 and outputs the remaining handoff information to the handoff information distribution unit 140A. The handoff information distribution unit 140A distributes the handoff information output from the distribution responsibility management unit 139. This process causes each of the nodes 200, 300, and 400 that has received the distributed handoff information to update the handoff information of its own. Thus, the handoff information held by each of the nodes 100, 200, 300, and 400 is synchronized. When there is no handoff information indicating that another node takes over the corresponding Key (step S309: NO), or when the own node does not take over the corresponding Key in the process at step S303 (step S303: NO), the inconsistency elimination unit 141 skips the process at step S310, and the handoff information distribution unit 140A skips the process at step S311.

When the process at step S311 is completed, or when the processes at steps S310 and S311 are skipped, the distribution responsibility management unit 139 checks the version of the corresponding Key of the data held by the own node (step S312). More specifically, when the responsible node determination unit 136 determines the distribution responsible node, the distribution responsibility management unit 139 checks the version of the corresponding Key through the data distribution management unit 133.

Upon completion of the process at step S312, the distribution responsibility management unit 139 determines whether data is new (step S313). More specifically, the distribution responsibility management unit 139 compares the version of the handoff information of the corresponding Key with the version of the corresponding Key of the data held by the own node to determine whether the data is new. When the comparison result shows that the version of the corresponding Key of the data held by the own node is greater than the version of the handoff information, the data is new (step S313: YES). Thus, in this case, the distribution responsibility management unit 139 distributes the latest data to the appropriate nodes (step S314). That is, the distribution responsibility management unit 139 distributes the latest data to the nodes 200, 300, and 400 through the data distribution unit 134A. This process eliminates the inconsistency that data is not synchronized. On the other hand, when the comparison result shows that the version of the corresponding Key of the data held by the own node is smaller than the version of the handoff information, the data is old (step S313: NO). In this case, as illustrated in FIG. 9, the distribution responsibility management unit 139 ends the process.

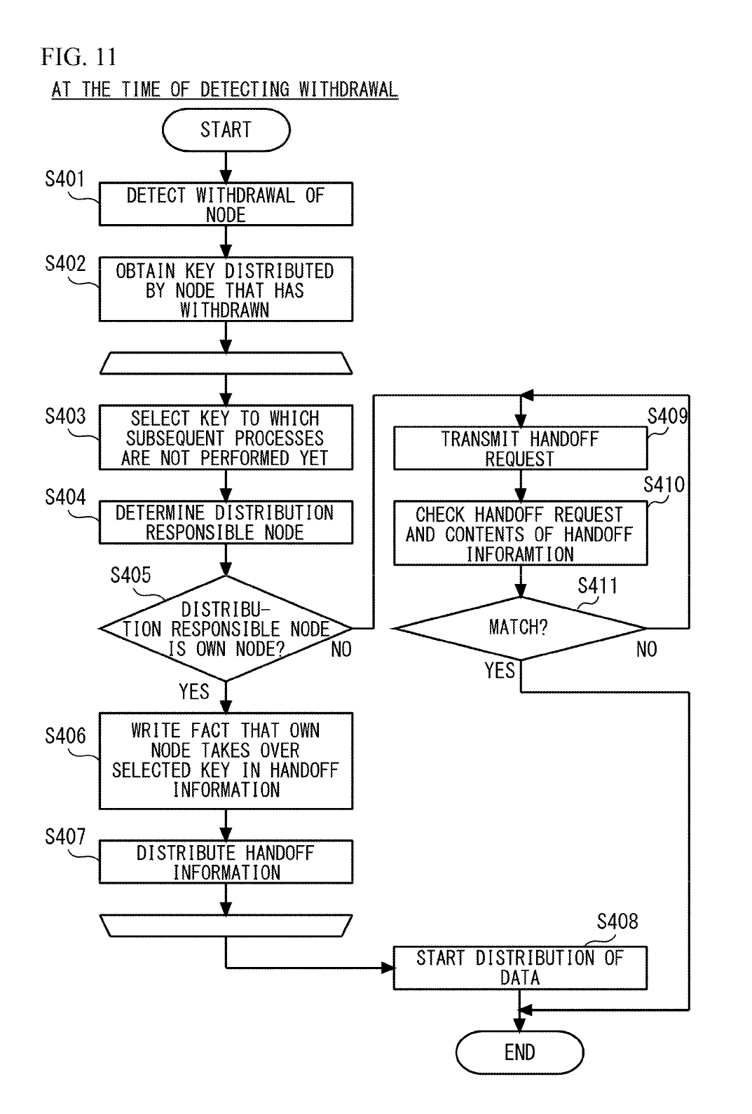

FIG. 11 is a flowchart of a process at the time of detecting withdrawal. More specifically, FIG. 11 illustrates a process executed when the node detection unit 138 detects withdrawal of a node (e.g., the node 300).

For example, when the node 300 withdraws from the information processing system S, the node detection unit 138 detects the withdrawal of the node 300 (step S401). More specifically, when the node 300 reports the withdrawal and the communication unit 120 receives the report, the withdrawal of the node 300 is reported to the node detection unit 138. This process causes the node detection unit 138 to detect the withdrawal of the node 300.

Upon completion of the process at step S401, the distribution responsibility management unit 139 obtains the Key distributed by the node that has withdrawn (step S402). For example, when the node detection unit 138 detects the withdrawal of the node 300, the distribution responsibility management unit 139 accesses the distributor information storage unit 135 and the handoff information storage unit 137, and obtains the Key of the data distributed by the node 300 that has withdrawn based on the distributor information and the handoff information.

Upon completion of the process at step S402, the distribution responsibility management unit 139 selects a Key to which the subsequent processes are not performed (step S403), and executes a loop process until the subsequent processes are performed on all the Keys. In the process at step S403, when the distribution responsibility management unit 139 selects one of Keys, the responsible node determination unit 136 determines the distribution responsible node (step S404). More specifically, the responsible node determination unit 136 determines the distribution responsible node of the Key selected by the distribution responsibility management unit 139.

Here, when the distribution responsible node determined by the responsible node determination unit 136 is the own node (step S405: YES), the distribution responsibility management unit 139 writes in the handoff information the fact that the own node is to take over the selected Key (step S406), and distributes the handoff information (step S407). In other words, the fact that the own node is responsible for distribution of the selected Key is written in handoff information, and the handoff information is distributed. Upon completion of the process at step S407, the process returns to step S403, and the distribution responsibility management unit 139 selects another Key to which the subsequent processes are not performed yet, and repeats the processes at steps S404 through S407. The above processes enable to identify all the Keys of which the distribution responsibility is taken by the own node (e.g., the node 100), and distributes the fact that the own node takes over the identified Key to other nodes (e.g., the nodes 200 and 400) by the handoff information. Upon completion of the process at step S407, the data distribution unit 134A starts the distribution of data (step S408), and ends the process.

On the other hand, when the distribution responsible node determined by the responsible node determination unit 136 is not the own node (step S405: NO), the distribution responsibility management unit 139 transmits a handoff request (step S409). More specifically, when the handoff information reception unit 140B does not receive the distribution of the handoff information by the determined distribution responsible node for a predetermined time, the distribution responsibility management unit 139 transmits a handoff request together with the selected Key to another node (e.g., the node 200 or the node 400) determined by the responsible node determination unit 136 through the handoff information distribution unit 140A. The handoff request is information for requesting the handoff of the distribution responsibility.

Upon completion of the process at step S409, the distribution responsibility management unit 139 checks the handoff request and the contents of the handoff information (step S410), and determines whether the handoff request matches the contents of the handoff information (step S411). The distribution responsibility management unit 139 can know whether another node (e.g., the node 200 or the node 400) has accepted the handoff request by sharing the handoff information. When the handoff request does not match the contents of the handoff information (step S411: NO), the distribution responsibility management unit 139 repeats the processes at steps S409 and S410. In other words, until the handoff request matches the contents of the handoff information, the distribution responsibility management unit 139 repeats the processes at steps S409 and S410. On the other hand, when the handoff request matches the contents of the handoff information (step S411: YES), the distribution responsibility management unit 139 ends the process. As described above, even during a period in which the distribution responsible node is not uniquely determined, distribution of data can be continued, and thereby, data consistency among nodes (e.g., among the nodes 100, 200, and 400) can be maintained.

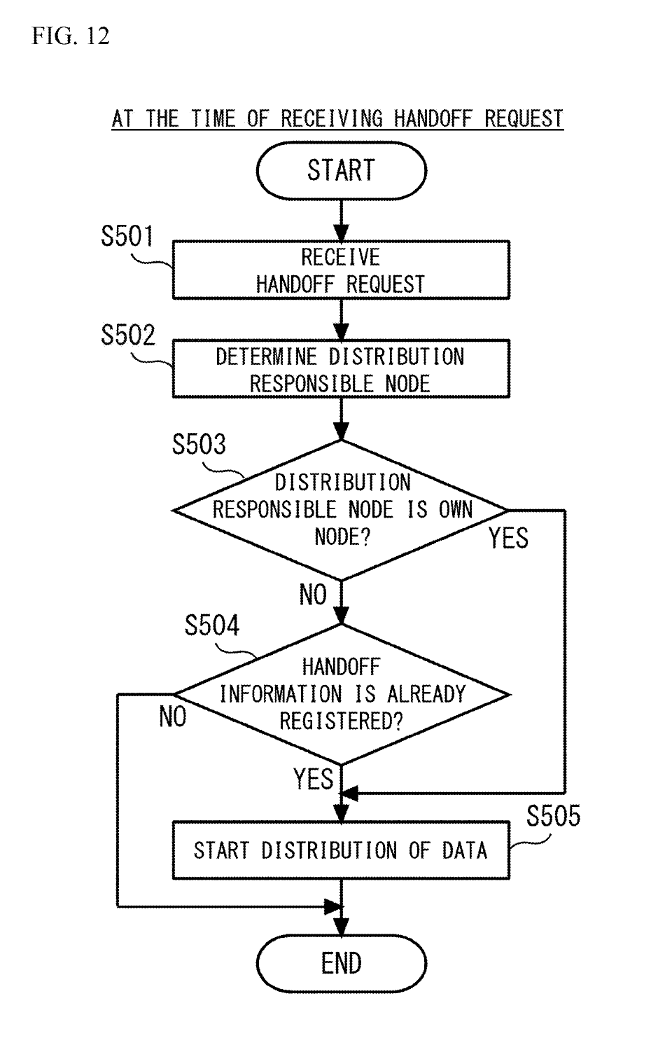

FIG. 12 is a flowchart of a process at the time of receiving a handoff request. More specifically, FIG. 12 illustrates a process executed when the distribution responsibility management unit 139 receives a handoff request.

When the distribution responsibility management unit 139 receives a handoff request through the handoff information reception unit 140B (step S501), the responsible node determination unit 136 determines the distribution responsible node (step S502). More specifically, the responsible node determination unit 136 determines the distribution responsible node of the Key transmitted together with the handoff request by the distribution responsibility management unit 139.

When the distribution responsible node determined by the responsible node determination unit 136 is not the own node (step S503: NO), the distribution responsibility management unit 139 determines whether the handoff information is already registered (step S504). More specifically, the distribution responsibility management unit 139 determines whether the handoff information of the corresponding Key is already registered. When the handoff information is already registered (step S504: YES), or when the distribution responsible node determined by the responsible node determination unit 136 is the own node (step S503: YES), the distribution of data is started (step S505), and the process is ended. On the other hand, when the handoff information is not registered yet (step S504: NO), the distribution responsibility management unit 139 skips the process at step S505, and ends the process.

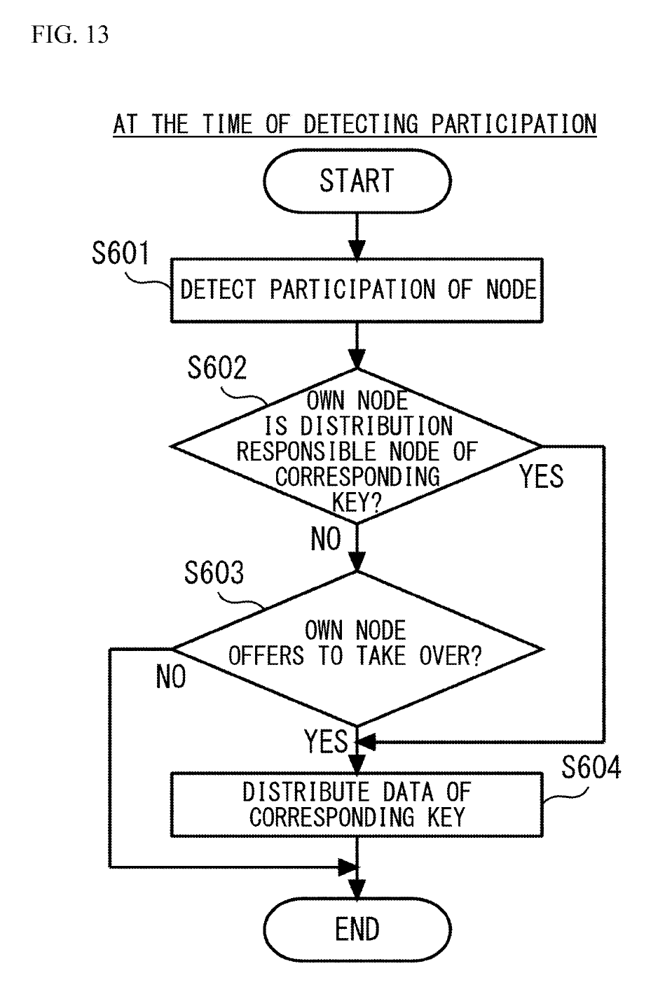

FIG. 13 is a flowchart of a process at the time of detecting participation. More specifically, FIG. 13 illustrates a process executed when the node detection unit 138 detects participation of a node (not illustrated).

For example, when a new node (not illustrated) participates in the information processing system S, the node detection unit 138 detects the participation of the node (step S601). More specifically, when a new node requests distribution of data, the communication unit 120 accepts the request, and reports the request to the node detection unit 138. This process causes the node detection unit 138 to detect the participation of the new node.

Upon completion of the process at step S601, the distribution responsibility management unit 139 determines whether the own node is the distribution responsible node of the corresponding Key (step S602). More specifically, distribution responsibility management unit 139 checks the distributor information storage unit 135, and determines whether the own node is the distribution responsible node of the corresponding Key. When the own node is not the distribution responsible node of the corresponding Key (step S602: NO), the distribution responsibility management unit 139 determines whether the own node offer to take over the corresponding Key (step S603). More specifically, the distribution responsibility management unit 139 checks the handoff information storage unit 137, and determines whether the own node takes the distribution responsibility of the corresponding Key. When the own node offers to take over the corresponding Key (step S603: YES), or when the own node is the distribution responsible node of the corresponding Key (step S602: YES), the data distribution unit 134A distributes data with the corresponding Key to the node that has newly participated (step S604), and ends the process. When the own node does not offer to take over the corresponding Key (step S603: NO), the distribution responsibility management unit 139 skips step S604, and ends the process.

As described above, the information processing system S in accordance with the present embodiment synchronizes data among a plurality of nodes 100, 200, 300, and 400. Each of the nodes 100, 200, 300, and 400 includes the same or similar middleware, and for example, the middleware 130 of the node 100 determines the distribution responsible node that has the responsibility for distribution of data from among the nodes 100, 200, 300, and 400 based on the distributed algorithm common to all the nodes 200, 300, and 400. Then, the middleware 130 distributes information for identifying the determined distribution responsible node to the remaining nodes other than the distribution responsible node. This configuration allows the immediate election of the distribution responsible node. Thus, the distribution of data does not delay, and the time required for making data consistent among the nodes 100, 200, 300, and 400 is reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An information processing system for synchronizing data among nodes, wherein
each of the nodes includes a processor configured to:
determine from among the nodes a node that has responsibility for distribution of the data based on a distributed algorithm common to all the nodes; and
distribute information for identifying a determined node to a remaining node other than the determined node.

2. The information processing system according to claim 1, wherein
when nodes that have the responsibility overlap among the nodes based on the information, the processor is configured to terminate the responsibility that a node other than one of overlapping nodes has based on the distributed algorithm.

3. The information processing system according to claim 1, wherein when the determined node is any of the nodes other than an own node, the processor is configured to request the any of the nodes to hand off the responsibility.

4. The information processing system according to claim 3, wherein
the processor is configured to request the any of the nodes to hand off the responsibility when distribution of the information by the determined node is not received for a predetermined time.

5. The information processing system according to claim 1, wherein
the processor is configured to:
when a version of data held by an own node is older than a version of the data included in the information distributed, request a node that has distributed the information to transmit data; and
when the version of the data held by the own node is newer than the version of the data included in the information distributed, transmit data to the node that has distributed the information.

6. The information processing system according to claim 1, wherein the processor is configured to, when detecting withdrawal of a node of the nodes, determine a node to which data distributed by a node that has withdrawn and the information held by the node that has withdrawn are to be handed off.

7. An information processing method for synchronizing data among nodes, wherein
a computer of each of the nodes executes a process, the process comprising:
determining from among the nodes a node that has responsibility for distribution of the data based on a distributed algorithm common to all the nodes, and
distributing information for identifying a determined node to a remaining node other than the determined node.

8. The information processing method according to claim 7, wherein
the process includes, when nodes that have the responsibility overlap among the nodes based on the information, terminating the responsibility that a node other than one of overlapping nodes has based on the distributed algorithm.

9. The information processing method according to claim 7, wherein the process includes, when the determined node is any of the nodes other than an own node, requesting the any of the nodes to hand off the responsibility.

10. The information processing method according to claim 9, wherein the process includes requesting the any of the nodes to hand off the responsibility when distribution of the information by the determined node is not received for a predetermined time.

11. The information processing method according to claim 7, wherein the process includes, when a version of data held by an own node is older than a version of the data included in the information distributed, requesting a node that has distributed the information to transmit data; and when the version of the data held by the own node is newer than the version of the data included in the information distributed, transmitting data to the node that has distributed the information.

12. The information processing method according to claim 7, wherein
the process includes, when detecting withdrawal of a node of the nodes, determining a node to which data distributed by a node that has withdrawn and the information held by the node that has withdrawn are to be handed off.

13. An information processing device of a plurality of information processing devices synchronizing data each other, comprising:
a processor configured to:
determine from among the plurality of information processing devices an information processing device that has responsibility for distribution of the data based on a distributed algorithm common to all the plurality of information processing devices; and
distribute information for identifying a determined information processing device to a remaining processing device other than the determined information processing device.
